(19) United States
(12) Patent Application Publication
(10) Pub. No.: US 2014/0195352 A1
(43) Pub. Date: Jul. 10, 2014

(54) Advertising On Computing Devices

(71) Applicants: Cassandra Louise Govan, South Melbourne (AU); Richard Peter Hayward, Fitzroy (AU)

(72) Inventors: Cassandra Louise Govan, South Melbourne (AU); Richard Peter Hayward, Fitzroy (AU)

(21) Appl. No.: 13/793,513

(22) Filed: Mar. 11, 2013

Related U.S. Application Data
(60) Provisional application No. 61/751,102, filed on Jan. 10, 2013.

(51) Int. Cl. G06Q 30/02

(52) U.S. Cl. CPC G06Q 30/0262
USPC 705/14.59

(57) ABSTRACT

The present invention relates generally to a method executable at a networked computing device having a display. The method generally includes (i) displaying advertising content on the display when the computing device is in a locked state in which interactions with the computing device are limited, (ii) receiving an unlocking user input to cause the computing device to enter an unlocked state in which interactions with the computing device are less limited than when in the locked state, and (iii) displaying, in the unlocked state, a home screen including an activatable image associated with the advertising content.

### CROSS-REFERENCE TO RELATED APPLICATIONS

This application claims the benefit of and priority to U.S. Provisional Patent Application No. 61/751,102 titled “Advertising On Computing Devices” and filed on Jan. 10, 2013, which is incorporated herein by reference in its entirety. This application is also related to U.S. patent application Ser. No. 13/793,194 (Attorney Docket No. 743414-700001USPT) titled “Advertising On Computing Devices” and filed on Mar. 11, 2013, by the same inventors, which is incorporated herein by reference in its entirety.

### FIELD OF THE INVENTION

The present invention relates to advertising on computing devices, such as mobile computing devices, and in particular to methods and systems for advertising on the lock screens of such devices.

### BACKGROUND OF THE INVENTION

The use of computing devices, and in particular, portable and personal computing devices, is increasing rapidly, in line with their increasing capabilities and decreasing costs. A large proportion of such devices, including smartphones and tablets, have an electronically driven display on which they can display information. In some configurations, the display is integrated with, or adjacent to, a user input device to form a touchscreen. In other configurations, the user input device takes the form of a keyboard adjacent to the display.

It is desirable to use this display to present advertising content to the users of the devices. However, in some circumstances (such as in the case of mobile telephones), display space is at a premium. This poses some technical and practical difficulties in presenting advertising content, as the display of such content would detract from the utility of the device, as it would mean that less user information would be displayed on the display when the advertising content is being displayed.

It is desired to address this or other shortcomings or disadvantages of the prior art, or at least provide a useful alternative.

### SUMMARY OF THE INVENTION

In accordance with at least one embodiment of the present invention there is provided a method executable at an advertising server connected, through a computer network, to a client computing device, the method including the steps of:
receiving through the computer network, from the client computing device, new advertising performance data relating to advertising content displayed on a display of the computing device when the client computing device was in a locked state in which interactions with the client computing device were limited, the new advertising performance data having been generated by the client computing device based on feedback user input;
updating, using one or more server processors, existing advertising performance data for the advertising content, using the new advertising performance data, to generate updated advertising performance data;
selecting, using one or more server processors, advertising content to be sent to the client computing device based, at least in part, on the updated advertising performance data.

### BRIEF DESCRIPTION OF THE DRAWINGS

Embodiments of the present invention are described herein, by way of example only, with reference to the accompanying drawings, wherein:

FIG. 1 is an exemplary architecture of an advertising content transmission and management system.

FIG. 2 is a flow diagram illustrating the process undertaken by the advertising application software upon its installation at a client computing device.

FIGS. 3a-3c are exemplary displays showing prompts to obtain information from a user that may be used in generating or modifying a user profile.

FIG. 4 is a flow diagram illustrating the process undertaken by an advertising server upon installation of advertising application software on a client computing device.

FIG. 5 is a flow diagram illustrating the process undertaken by a content service in presenting advertising on the lock screen of a client computing device.

FIG. 6 is an illustration of an exemplary image rating system by which the user can provide positive or negative feedback on the displayed image.

### DETAILED DESCRIPTION OF THE DRAWINGS

In many circumstances it is desirable to control access to computing resources, including computing devices. For example, in many office environments, computers are configured to require the entry of authentication information, such as a password, before use can be made of the computer. This reduces the risk of unauthorised users gaining access to the computing resources. More personal computing devices, such as smartphones, also generally enable a user to configure the device to require the entry of authentication information to prevent access to information stored on, and services provided by, the computing device.

In some circumstances, the use of authentication to control access to computing resources is considered unnecessary. For example, some owners of portable computing devices, such as smartphones, do not use any authentication system to control access. Even so, in the case of portable devices it is also undesirable to have the device always operable, as the device may then be accidentally operated in a pocket, bag or the like.

Accordingly, computing devices may be configured to include a “locked mode” during which interactions with the computing device are substantially limited. Where a computing device is protected by a password or other authentication information, the computing device will remain in the “locked” state until correct authentication information is entered. While the device is in a locked state, user input into the device (for example, by means of a keyboard, mouse, stylus, biometric input device or touchscreen) is limited to that required to enable the user to enter the authentication information. In some circumstances, other operations (such as restarting the computing device, or making an emergency call on a smartphone) may be available. However, a user cannot modify any data using the computing device without first being authenticated.

Similarly, where a computing device is not protected by a password or other authentication information, but may be operated unintentionally, the computing device requires some action by a user to “unlock” the device. In its locked state, the interactions with the computing device are limited to interactions which may unlock the device. Other possible interactions with the device in the “locked” state include viewing some data on the device. However, while the device is in a “locked” state, the device is not able to be used to modify any information, to avoid accidental modification of data. However, after the user has executed the unlock action (which is selected to be an action of a type which would normally only be taken on purpose, and not by mistake) all of the functionality of the computing device is available.

When the computing device is in a “locked” state, the display of the device may be activated to facilitate input of authentication information, or the execution of an unlock action. The information displayed on the display when the device is in a “locked” state is referred to as a “lock screen.” Although the lock screen may be a static display, it may also include a scrolling or otherwise dynamic display. The lock screen may instruct or suggest to a user of the device how the device may be unlocked. For example, it could display a password input box to enable user input of a password. Alternatively, it could show an image which may be moved or traced over to unlock the device. Other possible lock screen configurations would be known to a person skilled in the art.

When the computing device is “unlocked,” it may display a “home screen.” The “home screen” may include one or more static icons, the activation of which would result in the launching an application. The home screen may also include one or more dynamic “widgets,” the appearance of which changes in response to changing data within the application associated with the widget. For example, a weather widget may display the current air temperature. The unlocking of the computing device results in the computing device rendering the home screen, including any incorporated icons or widgets. When a widget is being drawn by the computing device, the computing device queries the application associated with the widget for data held by the application (for example current weather information), and uses that data to alter the appearance of the widget (for example, by causing the temperature displayed by the widget to be modified). In other embodiments, the widget maintains a data store that it uses to change its appearance, the data store being periodically refreshed with data from the application associated with the widget.

### Exemplary System Architecture

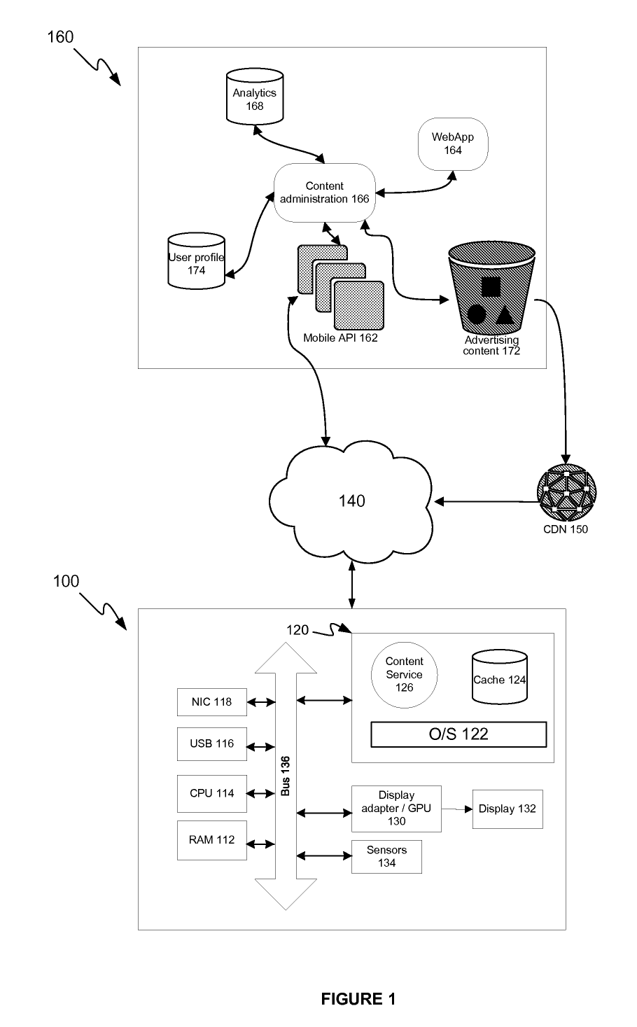

FIG. 1 illustrates an exemplary architecture of an advertising content transmission and management system. A networked (and in the present embodiment, mobile) computing device 100 contains a number of components common to most computing devices. These include on or more Central Processing Units (CPU) 114, Random Access Memory (RAM) 112 and an interface to external peripherals such as a Universal Serial Bus (USB) interface 116. The networked computing device 100 is capable of communicating with a computer network such as the Internet 140 by means of a network interface component, in the form of a Network Interface Card (NIC) 118. The NIC 118 is may be capable of communicating over both wired and wireless network links, and preferably is able to communication with protocols used in both wide area and local area networks. For example, the NIC 118 may include a wideband CDMA baseband modem and a wireless LAN interface for communicating over wireless networks that comply with the IEEE 802.11 standards.

Networked (and preferably mobile) computing device 100 also includes a number of user inputs, or sensors 134. These sensors include motion and orientation sensors and, if the mobile computing device has a touchscreen interface, the touch screen through which user inputs may be received. If the device uses a keyboard, stylus, or other input mechanism, these input mechanisms are also considered to use one or more sensors 134. Other potential sensors include barometric (pressure) sensors, ambient light sensors and camera inputs. The sensors 134 therefore include any form of input mechanism connected to CPU 114.

Data is stored on a data storage device 120, which is preferably a form of non-volatile memory. The data stored on the data storage device 120 includes operating system files 122 as well as applications and associated data.

Information generated by the CPU 114 using data stored on data storage device 120 is communicated to a user by means of one or more displays 132 connected to a display adapter (including a Graphics Processing Unit (GPU)) 130. The displays 132 may be manufactured together with one or more sensor components 134 which together form one or more touch screen displays, as known in the art. For ease of explanation, a singular display will generally be referred to below, although the present invention is equally applicable to devices having multiple displays.

Each of the components of the mobile computing device 100 identified above is interconnected by means of an internal computer network, such as a bus 136.

Mobile computing device 100 communicates through network 140 with an advertising server 160. Advertising server 160 includes components common to computing servers, including one or more server processors for executing computer programs stored non-volatile memory (such as hard disk) and loaded into volatile memory (such as dynamic random access memory), and a server network interface component for communicating with networked mobile devices through network 140. The computer programs include an operating system (providing at least a hardware abstraction layer) and one or more application programs. The hardware components of advertising server 160 are not shown in FIG. 1 for clarity, but some of the components (such as the server processors and volatile memory) can be considered to be part of the content administration subcomponent 166. Advertising server 160 includes a mobile Application Programming Interface (API) 162, to enable the mobile computing device 100 to interact with a content administration subcomponent 166. The mobile API 162 is exposed through a plurality of endpoints scaled across multiple servers, each endpoint facilitating secure communications between the advertising server 160 and the mobile device 100. For example, each endpoint may use Secure Sockets Layer (SSL) encryption to reduce the prospect of data being inspected as it travels between the mobile computing device 100 and the advertising server 160.

Content administration subcomponent 166 also has a data connection to a second interface, being web app 164. Web app 164 is a World Wide Web application that allows advertisers to manage advertising content stored in advertising content database 172 and to obtain read-only access to customer usage analytics stored in analytics database 168. Customer usage analytics are mirrored within analytics database from an operational data store inaccessible to web app 164, into a read only store accessible to web app 164. This ensures integrity of the data within the operational data store, while allowing the content administration subcomponent 166 to write analytics records at a speed unaffected by the use of the web app 164. The use of advertising content database 172 and analytics database 168 is explained further below.

The advertising content itself (which may contain, for example still images, dynamic images, videos and sounds) is stored in an advertising content database 172, and distributed to mobile computing devices 100 by means of a content delivery network CDN 150. The advertising content database 172 may be a distributed, externally hosted database such as Amazon.com's Simple Storage Service (S3). The use of such a database enables the advertising content to be easily available across multiple geographic regions. The use of a content delivery network 150 (such as those supplied by Akamai or Amazon.com) reduces content delivery latency by routing requests for content to the quickest available content store. Preferably the advertising content is compressed to ensure efficient storage and conserve bandwidth when the content is sent to a mobile device 100.

### Selecting Advertising Content

In at least one embodiment of the present invention, a user of a mobile device 100 obtains and installs an advertising software application. The advertising application may be made available on relevant software application stores (such as Apple, Inc's App Store, Google Play, or the Amazon App Store) to facilitate its installation by users.

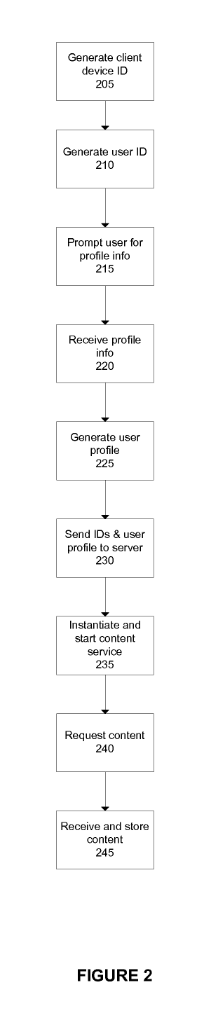

The process undertaken by the advertising application software upon its installation will now be described with reference to FIG. 2. Upon installation, the advertising application generates a client computing device identifier for identifying the mobile device 100 (step 205), and a user identifier for identifying the user of the mobile device 100 (step 210). The client computing device identifier may be generated from any hardware characteristic of the mobile device 100 including, for example, its Media Access Control (MAC) address or its International Mobile Station Equipment (IMEI) number.

Although in the presently described embodiment, the advertising application software (using one or processors, such as CPU 114) generates both a client computing device identifier and a user identifier, depending on the specific system architecture it may be sufficient to use a single identifier. In such circumstances, it is preferable for the single identifier to at least identify the user because, as will be further explained below, the advertising analytics are preferably primarily associated with the user, and not the mobile device itself.

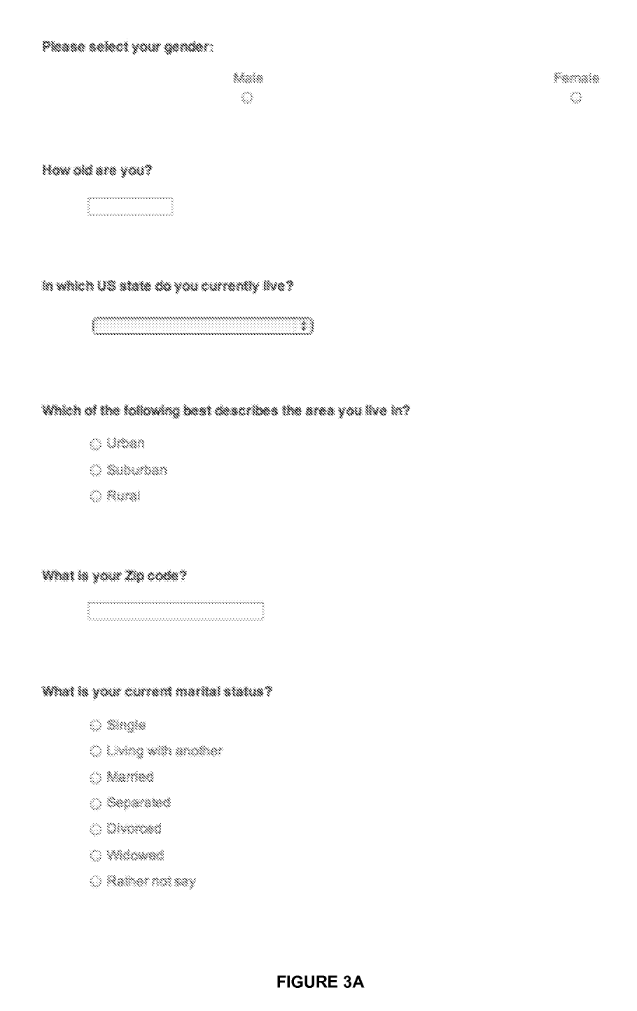

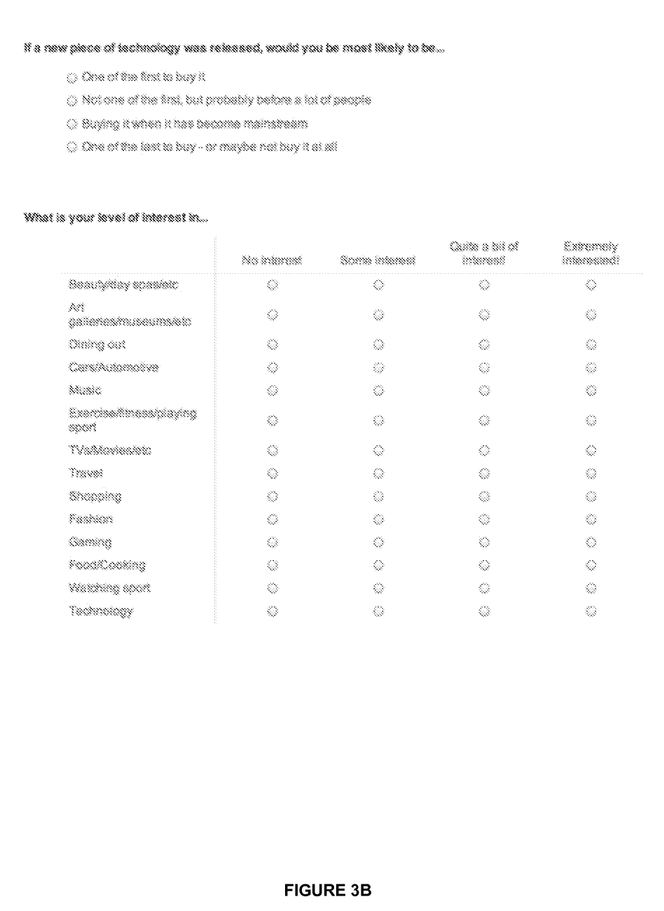

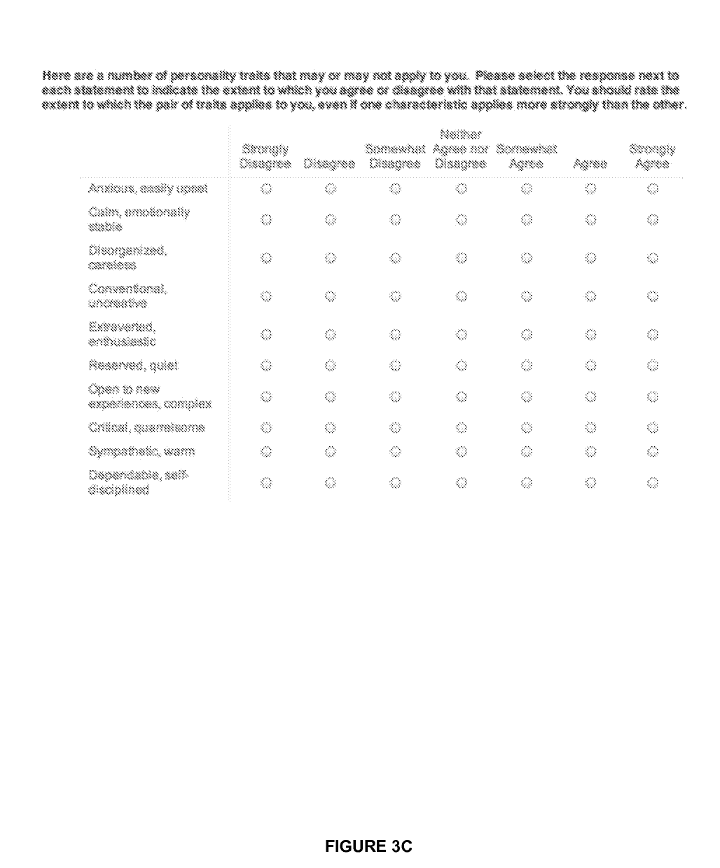

After generating the relevant identifiers, the advertising application software then optionally prompts the user (using the display 130) to enter information about the user that can be used to populate a user profile (step 215). FIGS. 3a-3c are illustrations of exemplary displays showing such prompts. The user may then respond to any or all of the prompts, and the advertising application uses the information it receives to generate a user profile (step 225). The user profile may contain information about the user (such as demographic and psychographic information) and the user's preferences and interests. Demographic information could include (but is not limited to) age and gender information. Psychographic information could indentify whether the user is extroverted or introverted, or is an early adopter. Other information that could be included in the user profile could relate to the user's lifestyle (for example, does the user live with his or her parents, and the number of children living with the user) and hobbies/interests. The profile information also preferably contains user financial account information, such as information identifying a bank account or service provider account of the user. As explained in more detail later, this information may be used to provide the user with a benefit (possibly including a financial benefit), such as a direct deposit of funds into the user's selected bank account. The user profile may also contain user authentication details and transaction history.

Although the user profile may be generated from information received from a user's response to a plurality of prompts shown on a display, a user may find it inconvenient to respond to the prompts, and instead may direct the networked computing device to retrieve relevant information from other computing devices using the one or more processors 114 communicating through a network interface component such as NIC 118. Those other computing devices may store remote profile data that may be used by the processors 114 of the networked computing device to generate user profile information. For example, the mobile computing device may prompt the user for remote profile authentication information (such as a user name and password for a social networking site to which the user is a member), and retrieve remote profile data from other computing devices (such as the servers servicing the social networking site) using that authentication information. In this way, the mobile computing device may retrieve information, for example, relating to the user's interests or hobbies. This information may be used by the processors 114 to generate profile information, which is used by the networked computing device to select advertising content to be displayed.

The user may be given the choice of responding to a series of questions, or providing authentication details for remote profile data stored on other computing devices (such as social networking sites or webmail/email accounts.) If the user provides authentication details for remote profile data, the computing device can retrieve from the other computing devices, using a network interface component 118, information about the user, and use that data (instead of the responses to questions) to generate user profile information. In one embodiment, the computing device can transmit authentication details received from the user to the advertising server 160, which in turn can retrieve from other computing devices information about the user, and use that information to generate, using the one or more server processors, a user profile which it subsequently transmits to the mobile computing device.

The one or more processors 114 associate the user profile with the user ID and client device ID, and send this to an advertising server, such as advertising server 160 illustrated in FIG. 1 (step 230), using the network interface component 118. Although in the described embodiment the mobile device 100 (using the one or more processors 114) creates a user profile, and associates the user ID and client device ID with the profile before transmission to the advertising server 160, other profile creation techniques are possible. For example, the mobile device 100 may send one or more of the user ID and client device ID to the advertising server 160, and receive from the advertising server 160 a token. This token is sent back to the advertising server 160 together with any user profile information, to enable the advertising server 160 to create a user profile from the user profile information, and associate that user profile with the previously received user ID and client device ID. In another exemplary process, a user may directly access advertising server 160 to create a user profile (e.g. by using a Web browser), and in doing so input a user name and password (or other authentication information). The user can then enter that authentication information into the advertising application software on the mobile device 100, enabling the advertising server 160 to associate the specific instance of the advertising application software, or the specific mobile device 100, with the user profile previously created by the advertising server 160 from information directly entered into the advertising server 160 by the user. Any manner of generating a user profile and subsequently identifying that user profile is within the scope of the present invention.

The advertising application software also instantiates and starts a background content service 126 (step 235). The instantiation and launching of the content service 126 may take place before, after, or simultaneously with the generation of client device and user IDs and the user profile. However, the content service 126 must wait for the generation of the client device and user IDs, and for the transmission of the user profile to the advertising server 160, before it requests from the advertising server 160 (more specifically the content administration subsystem 166 through the mobile API 162) advertising content to be stored in a cache 124 on data storage device 120 (steps 240 and 245). The request sent by the content service 126 includes the unique IDs, to enable the content administration subsystem 166 of advertising server 160 to select, using one or more server processors, advertising content to send to the mobile device 100 based at least in part on the user profile associated with the IDs. The content service 126 also receives from the advertising server 160 one or more advertising content identifiers associated with the advertising content it receives from advertising server 160. As further explained below, this facilitates advertising analytics (including updating advertising performance data).

The content is preferably received in a compressed form to reduce bandwidth requirements. Depending on the space available in data storage device 120 of mobile computing device 100, and on the specific configuration of the content service 126, the advertising content received from advertising server 160 may be stored in cache 124 in a compressed or uncompressed form.

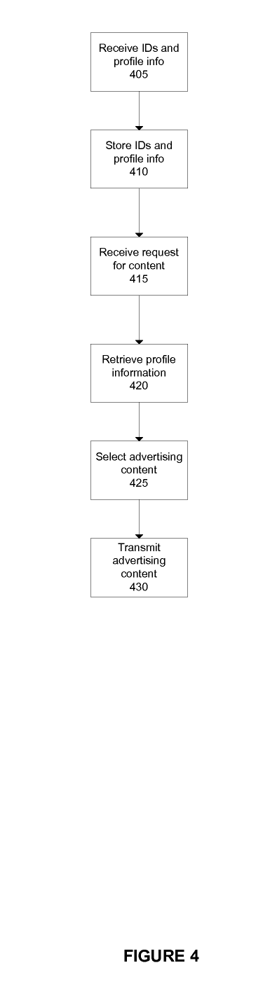

FIG. 4 illustrates exemplary steps taken by an advertising server 160 upon installation of advertising application software on a portable computing device 100. At step 405 the advertising server 160 receives the unique IDs (preferably including a client device ID and a user ID) and the user profile information sent by the content service 126 installed on the portable computing device 100 in step 230 shown in FIG. 2, through computer network 140. The content administration subcomponent 166, using the one or more server processors, then stores the profile information in user profile database 174, maintaining its association with the user ID and client device ID. As described above, other mechanisms for generating the user profile, and subsequently identifying the user profile, are also able to be used with the present invention.

At step 415, the advertising server 160 receives, through computer network 140, a request for advertising content from the portable computing device 100 (see step 240 of FIG. 2), the request including the client device ID and the user ID. One or either of the client device ID and user ID is used by the one or more server processors to identify the associated profile and retrieve profile information (step 420). This profile information is used by the one or more server processors to select appropriate advertising content from advertising content database 172 for transmission to mobile computing device 100 (steps 425 and 430).

One way of selecting appropriate advertising content is to associate each piece of advertising content with one or more tags or other form of metadata. The tags could relate to subject matter (e.g. Automotive, Technology, Fashion), demographic information (18-35 years old, lives in Spain) or psychographic information (traditional, Christian). These tags are targeting tags, in that they identify the target audience for the advertisement. Similarly, a user profile may contain tags (or other forms of data) relevant to the user. In at least one embodiment, selecting appropriate advertising content to send to a mobile computing device 100 involves the one or more server processors retrieving tags from the user profile identified by the client device ID or user ID, and selecting advertising content in advertising content database 172 having the greatest number of tags in common with those retrieved.

The advertising content may also be associated with other analytics metadata, as further described below.

The selected advertising content is sent to mobile computing device 100 through content delivery network 150. The content service 126 caches the received advertising content in cache 124 of the mobile device 100.

### Lock Screen Advertising

In at least some embodiments of the present invention, the advertising content cached in cache 124 of mobile computing device 100 is presented to the user as part of, or immediately prior to, the presentation to the user of a lock screen. As explained above, a lock screen is a static or dynamic image presented to the user on one or more displays of a computing device when the computing device is in a “locked” state (a state in which interactions with the computing device are limited).

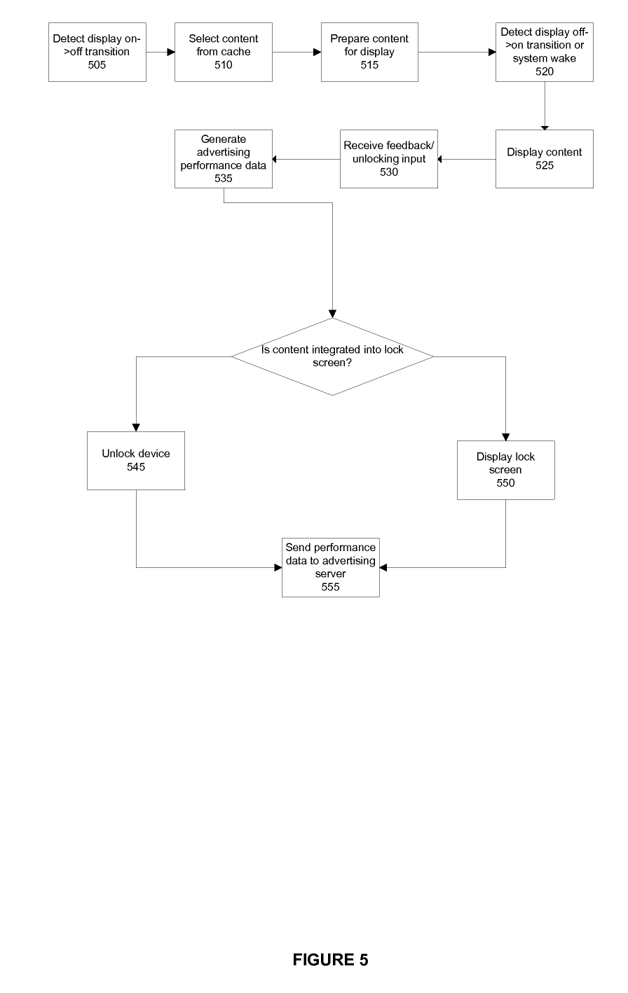

The operation of the content service 126 in presenting advertising on the lock screen of a computing device will now be described with reference to FIG. 5.

At step 505 the content service 126 detects a transition of the mobile computing device 100 from an “unlocked” state to a “locked” state. This state transition may be triggered by user input (for example, the user may press a power/sleep or lock key, button or user-interface element) or may be triggered by software (including the operating system 122) executing on the mobile computing device 100 (for example, the mobile computing device 100 may transition to a “locked” state on instructions from the operating system 122 on the expiration of a user-definable timeout period). The change of state from “unlocked” to “locked” may be accompanied by the display 132 becoming inactive, or “turning off.” The change in state may a system event to which content service 126 can subscribe. This enables content service 126 to determine when the state of the mobile computing devices changes from the “locked” state to the “unlocked” state, and vice versa.

In another embodiment, instead of detecting a lock state transition of the mobile device 100, the content service 126 detects a transition of the display of the mobile computing device 100 from an “on” state to an “off” state. As with the lock state transition, the display state transition may be triggered by user input, or by software executing on the mobile computing device 100. The content service 126 may monitor the display state to detect the transition. Alternatively, the operating system 122 executing on the mobile computing device 100 may broadcast an event upon changes to the display state, this broadcast being able to be detected by the content service 126.

Any change in state of the mobile computing device 126 may be used, although in preferred embodiments of the present invention, the transition of the mobile device 100 from an “unlocked” state to a “locked” state is detected.

Upon detection of transition from “unlocked” to “locked” (or, in other embodiments, upon detection of any other change in the state of the mobile computing device 100), the content service 126 selects from the cache 124 advertising content to be displayed when the lock screen is next displayed to the user (step 510).

The content service 126 may use any suitable algorithm for selecting the advertising content from the cache 124. For example, the content service 126 may associate with each piece of advertising content in the cache an indication of when the advertising content was last displayed on the lock screen. This indication may be used to select advertising content that was least recently displayed. Other criteria and algorithms may be used to select advertising content from the cache 124. For example, the content service 126 may select advertising content at random, or on a rotating schedule. Alternatively, it may use criteria such as the time of day, location of the mobile computing device, and usage patterns of the user of the mobile device 126. Where the mobile device 126 stores a cache of the user profile stored in user profile database 174, the information in the user profile may also be used by the content service 126 in its selection of advertising content to display. (The user profile may be cached by mobile device 126 in cache 124). These and any other criteria may be combined, or used in conjunction with one or more filters which, for example, could ensure that inappropriate ads are not displayed to minors.

The selected advertising content is then optionally prepared for display (515). For example, the advertising content may need to be resized, resampled or repositioned.

When the content service 126 detects an attempt by a user to use the mobile computing device 100 when the mobile computing device 100 is in a “locked” state (which often corresponds to a display state transition from “off” to “on” triggered through a user input, or a change in state of the mobile computing device 100 from a “sleep” state to a “wake” state) (step 520), it displays the advertising content in conjunction with other display elements of the lock screen (step 525). That is, the lock screen displays the advertising content together with any other user interface elements of the lock screen. Where it is not possible to modify the lock screen of the device to include advertising content, the advertising content may be displayed prior to the lock screen being displayed. In such a configuration, the user will need to dismiss the advertising content before being presented with the lock screen.

Embodiments of the present invention may be implemented on computing devices 100 using the Android™ operating system (although the invention may be implemented using any suitable operating system). This operating system 122 enables background services, such as content service 126, to execute code without user interaction and without an associated user interface in an active state. The content service 126 may be configured to subscribe to Android™ system events in order to be notified when the computing device 100 moves between states. This means that the content service 126 will be notified when the mobile device changes lock state either through the user initiating a change of state by using one or more user inputs such as a power button (or other sensor 134), or through a system timeout. Similarly, the Android™ OS issues a broadcast message to any components registered on the system (such as content service 126) that are listening to the device wake event, which may be triggered by the user turning on the display by pressing a button, touching the screen, moving the device, or through the use of any other user input.

Once notified that a device wake event has occurred, the content service 126 starts a specific activity (referred to herein as the Advertising Content User Interface Activity), and provides the activity with advertising content that it had previously selected and prepared. The Advertising Content User Interface Activity is marked as being shown “when locked” using the Window Flag FLAG_SHOW_WHEN_LOCKED. This ensures that the activity's user interface is elevated above any other user interface elements of the lock screen.

Although presently deprecated, the Android™ OS provides a mechanism to manage (query and edit) the current state of the keyguard (which is essentially the lock screen unlocking mechanism) using a class called KeyguardManager (http://developer.android.com/reference/android/app/KeyguardManager.html). This class can be used to disable the users' current keyguard, and so provide a new lock screen incorporating the selected and prepared advertising content.

Before installation of the advertising application software, a user is able to configure a keyguard mechanism such as PIN code, password, pattern or biometric in order to unlock the mobile computing device 100. Installation of the advertising application software by the user on mobile computing device 100 will cause the keyguard mechanism to appear augmented with the relevant advertising content.

Where the KeyguardManager class cannot be used, using Android's “Activity on Top” functionality enables the Advertising Content User Interface Activity to be displayed above any keyguards. Where this functionality is used, the Advertising Content User Interface Activity must be dismissed to expose the underlying keyguard (lock screen).

### Cache Maintenance

As described above, advertising content received from the advertising server 160 through computer network 140 is stored by content service 126 in cache 124. Each piece of advertising content stored in cache 124 is associated with an advertising content identifier (assigned by the advertising server 160), an expiry date, and a version number.

The content service 126 periodically requests new advertising content from advertising server 160. The advertising content identifier associated with each piece of received advertising content is compared with the advertising content identifiers associated with advertising content in the cache 124. Where the advertising content identifier of a piece of received advertising content is the same as an advertising content identifier associated with advertising content stored in the cache 124, the version numbers of the received content and stored content are compared to determine whether to discard the received content (where the version numbers are identical, or whether version number of the content in the cache is greater than the version number of the received content) or to replace the stored content with the received content (where the version number of the received content is greater than the version number of the stored content).

Alternatively, instead of the mobile computing device 100 receiving advertising content which it may subsequently discard, the mobile computing 100 may send to the advertising server 160 advertising content identifiers and version numbers for advertising content in cache 124, to enable the advertising server 160, using one or more server processors, to select and send to the mobile computing device 100 advertising content that does not replicate, and/or is newer than, advertising content already in cache 124.

The content service 126 also periodically checks the expiry date of advertising content in the cache and removes from the cache advertising content that has expired.

### Feedback Measurement

As described above, advertising content is displayed either as part of a lock screen or immediately prior to the display of a lock screen. Where the advertising content is displayed as part of a lock screen, the user must undertake some action (through one or more user inputs) with respect to the lock screen to unlock the device. This action also operates to dismiss the lock screen (including any incorporated advertising content). The user is likely to have made at least some visual observation of the lock screen on the display before dismissing it. Accordingly, an advertisement is very likely to be viewed if it is displayed as part of a lock screen. The unlocking of the device (by means of a lock screen having embedded advertising content) may be considered equivalent to the user having seen the advertising content.

Accordingly, a mobile computing device 100 may display advertising content on its display when it is in a locked state (a state in which interactions with the computing device are limited). It receives (from the user), through one or more user inputs, an unlocking user input (such as a button press or touchscreen gesture) to unlock the computing device 100 and thereby cause the computing device 100 to enter an unlocked state (in which interactions with the computing device 100 are less limited than when in the locked state). The unlocking of the device 100 triggers the generation, by one or more processors (such as CPU 114), of advertising performance data based on the unlocking user input. The advertising performance data may include the number of times the advertising content has been displayed, calculated by the one or more processors as being the same as the number of interactions a user has with the advertising content. For example, an interaction counter may be associated with advertising content in the cache 124. Each time the computing device 100 is unlocked where the lock screen has embedded within it, or displayed above/before it, advertising content, the interaction counter associated with that advertising content may be incremented by the one or more processors.

Other forms of advertising performance data are possible. For example, time data representative of the length of time for which the lock screen incorporating an advertisement is displayed before being dismissed (by the device being unlocked) may be generated by the one or more processors and stored individually, or accumulated to generate an accumulated display time. For example, a timer may be started by the one or more processors when the advertising content is displayed, and stopped by the one or more processors when the unlocking user input is received. The elapsed time may be represented by time data. The time data may be stored individually for each exposure (display) of the advertising content. Alternatively, the time data may be added to accumulated time data. The accumulated time data represents the total (accumulated) exposure time of the advertising content. As described below, this data may be used when selecting advertising content for display on the computing device 100, or for transmission to computing device 100 by advertising server 160. For example, advertising content that has been displayed, in total, for its intended exposure time will not be selected again for display in preference to other advertising content that has not been displayed, in total, for its intended exposure time. Other forms of advertising performance data are known in the art.

The advertising performance data is associated, by the one or more processors, with the advertising content that is displayed on the lock screen at the time the mobile computing device 100 is unlocked. The advertising performance data, the advertising content identifier identifying the advertising content, and one or both of the client device ID and user ID are sent to content administration sub-component 166 by the one or more processors using a network interface component.

As indicated above, the unlocking user input, received through one or more user inputs, may be a button press or a touchscreen gesture, or any other user input. It may involve the entry (through one or more user inputs) of authentication information, which includes any mode of entry of any secret or other authentication, and could include entry of a password or swipe pattern, a series of movements of the mobile device 100, the speaking of a predetermined series of sounds or words, and the entry of biometric information.

More than one action may result in the unlocking of the device 100. That is, there may be a plurality of possible unlocking user inputs. For example, although the mobile computing device 100 may be unlocked by moving a finger more than a threshold distance while touching the touchscreen of the device 100, the direction of movement of the finger on the screen may be mapped to a plurality of predefined directions. That is, the mobile computing device 100 may be unlocked by a movement (or swipe) in any direction, but the direction of movement may represent user feedback on the advertising content displayed on the lock screen.

Where only a single unlocking action is possible, there is a very limited amount of advertising performance data than can be generated by the one or more processors. However, where there are multiple possible unlocking actions, the choice of unlocking action made by the user may provide information on the user's views of the advertising content. For example, if the user gestures upwards on the touchscreen of the mobile device 100, this could be considered positive feedback. Similarly, if the user gestures downwards on the touchscreen of the mobile device 100, this could be considered negative feedback. This feedback is used by the one or more processors to generate advertising performance data (step 535), which, as described above, is associated with the user ID or client ID, and the advertising content identifier (although it could be associated only with a single identifier), and sent to the advertising server 160 (step 555) using the network interface component.

A plurality of possible unlocking user inputs is also possible where the unlocking user inputs must involve the entry, through one or more user inputs, of user authentication information. For example, the lock screen may display a password entry area. Although two passwords may be used to unlock the device, the use of the first password may represent positive feedback, and the use of the second password may represent negative feedback.

As described above, in some circumstances it may not be possible to display advertising content on the lock screen itself, and in these circumstances the advertising content is shown before (or on top of) the lock screen, and must be dismissed before the lock screen is exposed to the user. The dismissal of the advertising content screen is achieved by the user providing feedback user input, through one or more user inputs. The feedback user input may involve similar mechanisms to the unlocking mechanisms described above in relation to lock screens which incorporate the advertising content.

This means that if the advertising content is able to be integrated into the lock screen, receiving unlocking user input (through one or more user inputs) will result in the device being unlocked (step 545). However, if content is unable to be integrated into the lock screen, receiving feedback user input (again, through one or more user inputs) will result in the lock screen being displayed (step 550).

In some embodiments only the advertising performance data and the advertising content identifier are sent from the mobile computing device to the advertising server 160 using the network interface component. In such circumstances, the advertising server 160, using the one or more server processors, can modify metadata (such as existing advertising performance data) related to the advertising content identified by the advertising content identifier based on the received advertising performance data. For example, advertising content identifiers associated with negative advertising performance data may be used by the advertising rating server to modify rating metadata (such as existing advertising performance data) associated with the advertising content identified by the advertising content identifiers. In this way, performance data received from mobile devices 100 (that is, new advertising performance data) is used to modify or update existing performance data.

In other embodiments, the advertising performance data, the advertising content identifier, and one or more of the client device ID and user ID are sent from the mobile computing device 100 to the advertising server 160 using the network interface component. This enables the existing performance data for the advertising content stored in the advertising content database 172 to be modified by the one or more server processors in view of the user profile or client device characteristics. For example, some advertisements may be rated more highly when displayed on 10-inch screens, compared to when displayed on 3.5-inch screens. Similarly, some advertisements may gain more positive feedback from male users than from female users. Also, as described further below, transmitting the user ID to the advertising server 160 through the network interface component enables the advertising server 160, using one or more server processors, to maintain viewing data representing the type and/or number of advertisements viewed by users. This viewing data may be used to select a reward to be given to users, as further explained below.

The advertising performance data need not be stored in advertising content database 172, and is preferably stored in analytics database 168. The advertising performance data may take any form (including metadata associated and stored with advertising content), but where analytics database 168 is used, the advertising performance data may be stored by the one or more server processors as a plurality of event records, each event record including an advertising content identifier identifying the advertising content to which the record relates. Where one or more of the client device ID and user ID is also sent from the mobile computing device 100 to the advertising server 160 (through the network interface component), the client device ID and/or the user ID may also be included by the one or more server processors in the event record stored in analytics database 168. In such an embodiment, each event record links the user ID (or client device ID) with advertising content. The event records may also include an “event type” field (having data representing the feedback user input), time stamp information and location information.

The advertising performance data associated with a piece of advertising content is the plurality of event records identifying that piece of advertising content. Where new advertising performance data is received through the computer network 140 (in the form of a new event record, or information sufficient to enable the advertising server 160 to generate a new event record), the addition of the new event record to analytics database 168 by the one or more server processors has the effect of updating the existing advertising performance data.

Although in the embodiments described above advertising performance data is modified by the advertising server 160 (using one or more server processors) based on new advertising performance data, in other embodiments the content service 126 maintains advertising performance data associated with advertising content stored in cache 124. That is, new advertising performance data is used by content service 126 to modify or update existing performance data associated with advertising content in cache 124 using the one or more processors 114. This modified performance data can be sent to the advertising server 160 (along with relevant advertising content identifiers) periodically, to enable advertising server 160, using one or more server processors, to modify its stored existing performance data. This embodiment enables the serving of advertising content from the cache to be more quickly tailored to user preferences, reducing the need to communicate with the advertising server 160.

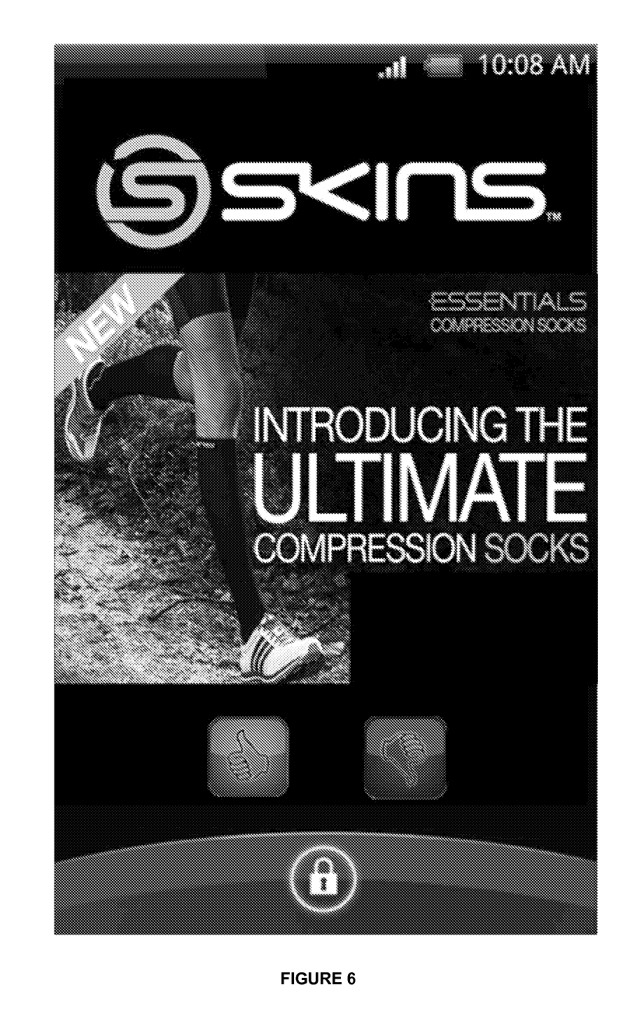

The lock screen with integrated advertising content, or the advertising content screen above/before the lock screen (jointly referred to as the advertisement screen), may include user interface elements that facilitate the entry of feedback user input, or the selection of more than one unlocking user input. For example, the advertisement screen may include a thumbs-up image and a thumbs-down image (an example of which is shown in FIG. 6). If the user touches the thumbs-up image, this represents positive feedback on the advertising content, and the advertisement screen is dismissed (either unlocking the device, or showing the lock screen). Similarly, if the user touches the thumbs-down image, this represents negative feedback on the advertising content.

Although in the embodiment described above the user interface elements which facilitate entry of feedback user input are displayed on the display along with the advertisement screen, in an alternative embodiment the user can provide feedback on the advertising content using the advertising application. This alternative embodiment preferentially includes an incentive to encourage the user to open the advertising application to provide feedback. For example, a user may receive some, or additional, user benefits (further described below) for providing feedback on the advertising content. For example, although a user may obtain a $10 a month discount on their mobile telecommunications services for having the advertising application installed on their mobile telephone, they may obtain an additional 25c discount for each advertisement for which they provide feedback, regardless of whether that feedback is positive or negative.

In this embodiment, after the user has unlocked the client device 100 using one or more user inputs, the user can launch the advertising application. The advertising application may display on the display a plurality of visual identifiers (e.g. thumbnail images or representative text) identifying advertising content recently displayed to the user. The user can use the one or more user inputs to select advertising content using the visual identifiers, resulting in an image such as that shown in FIG. 6 being displayed to the user on the display. When the user presses a thumbs-up or thumbs-down image, this feedback is recorded by the one or more processors and sent to the advertising server 160 using the network interface component, as described further below.

A variation of this embodiment involves displaying on the display, in the unlocked state, an activatable image associated with the advertising content. Activating the image launches the advertising application, which, as described above, a user can use to provide user feedback on the advertising content. The user feedback may be used by the one or more processors to generate advertising performance data as described above.

As described above, when a user unlocks the networked computing device using one or more user inputs, they may be presented with a “home screen.” The home screen may contain a “widget” associated with the advertising application. Activating the “widget” (for example by touching a touchscreen at the location of the widget, or executing a gesture over the widget) will result in the launching of the advertising application. Although in one embodiment a static icon is used on the home screen (activation of the static icon resulting in the launching of the advertising application), it is preferable to use the dynamic nature of a “widget,” as the appearance of the widget may be dynamically modified to correspond to the advertising content displayed on the display when the computing device was in a locked state.

In this embodiment, after a user is presented with the advertising content using the display, and subsequently unlocks the device using one or more user inputs, the user is presented with a home screen including an advertising application widget. In rendering the widget, the device requests data from the advertising application. The advertising application provides data to the device that enables the device to generate a widget having an appearance which corresponds to the advertising content displayed to the user on the display before the user had unlocked the device using the one or more user inputs. Preferably, the appearance of the widget (as generated by the device based on data from the advertising application) is visually recognisable as being associated with the advertising content displayed to the user on the display before the device was unlocked using the one or more user inputs. In one embodiment, the widget takes on the appearance of a reduced-size (or iconified) representation of the advertising content. That is, the widget has the appearance of an image that is substantially identical to the advertising content, but is of reduced dimensions compared with the advertising content. For some types of advertising content (for example content that contains detailed information), a smaller representation of the advertising content may be difficult to recognise. Accordingly, in an alternative embodiment, the appearance of the widget may take the form of an image that is substantially identical to a portion of the advertising content (for example, a brand logo, a person's face etc). Regardless of the appearance of the widget, it is preferable for the user to clearly associate the widget with the advertising content that was just presented to the user before the user unlocked the device.

By presenting such a widget (or icon) on the home screen of the device, the user may simply and quickly access the advertising application to provide the user feedback. Furthermore, the advertising content may be presented to the user twice; once before the user unlocks the device, and once in the form of the appearance of a widget on the home screen of the device.

As described above, activation of the widget may result in the launching of the advertising application, enabling the user to provide feedback on the advertising content. However, in an alternative embodiment, activation of the widget launches the advertising application, and the advertising application immediately presents to the user on the one or more displays a landing page associated with the advertising content. The advertising application may present the landing page by directly rendering the landing page on the display, or by sending a Uniform Resource Locater (URL) or other network identifier to an external application (such as a web browser) for presentation to the user. Shortly before or after presenting the landing page, the advertising application uses the one or more processors to update the advertising performance data associated with the advertising content (registering the “click through” by the user).

An alternative, or additional mechanism by which rapid access to the advertising application may be provided includes launching the advertising application based on the unlocking user input. For example, a lock screen may include an icon representing the advertising application. Moving the icon in one direction (for example, to the left) may result in the device being unlocked, and the advertising application being immediately launched. Moving the icon in a second direction (for example, upwards) may be interpreted as positive user feedback, and moving the icon in a third direction (for example downwards) may be interpreted as negative user feedback. That is, the unlocking user input may not only unlock the device, and potentially provide feedback on the advertising content displayed to the user while the device is locked, it may also operate to launch the advertising application.

### Serving Advertising Content Based on Advertising Performance Data

As described above with reference to FIG. 4, the advertising server 160 responds to requests for advertising content from the portable computing device 100. A request for advertising content is made when the advertising application software is first installed on the mobile computing device 100. Also as described above with respect to cache maintenance, the content service 126 periodically requests new advertising content from advertising server 160.

The advertising content stored in advertising content database 172 is associated, by the one or more server processors, with advertising performance data. That is, each piece of advertising content in advertising content database 172 is associated with at least one performance metric. As described above, the existing performance data associated with advertising content in database 172 is updated by the one or more server processors using new advertising performance data received from mobile computing devices 100. The advertising performance data may be stored in analytics database 168.

Upon receiving a request for advertising content from a mobile computing device 100 through computing network 140, the advertising server 160 selects, using one or more server processors, advertising content (lock screen advertising content) to be displayed on the display of the mobile (client) computing device when the client computing device is in a locked state in which interactions with the client computing device are limited. In doing so, the advertising server 160 may, using the one or more server processors, undertake a tag correlation process as described above. However, in addition, the advertising server 160 preferably also bases the selection of advertising content to be sent to the mobile computing device 100 on existing performance data. For example, advertising content having received high performance data for male users (possibly by receiving large numbers of positive feedback from male users) should be selected to be sent to male users in preference to advertising content having received low performance data for male users. Similarly, advertising content that receives higher performance when displayed during evening hours should be preferentially selected for transmission to the mobile computing device 100 in response to early evening requests for advertising content, or requests from a mobile computing device 100 that is most used in the evening.

Advertising content may also include other metadata, in addition to performance data. An example of this additional metadata is serving constraints, which are rules which assist in determining when the advertising content should be displayed. This additional metadata may include information identifying a target segment for the advertising content (such as target age ranges, location, preferences), date range information (identifying the dates within which the advertisement must be displayed), daily window time information (identifying the time window within the day during which the advertisement should be displayed), and a daily limit parameter identifying the maximum number of times in a single day the advertising content should be displayed. This metadata may be used both by advertising server 160 (in determining advertising content to send to client computing device 100) and content service 126 (in determining advertising content to select to display on display 132).

### Updating User Information Based on Feedback

As described above, when the advertising application software is first installed on the mobile computing device 100, it receives information from the user of the mobile computing device 100 which one or more processors use to generate a user profile. The user profile is subsequently sent to advertising server 160 through a computer network, and the one or more server processors store the user profile. The user profile is associated with at least a user ID, and preferably both a user ID and a client device ID, and may contain authentication credentials, demographic and psychographic information and the like, and a transaction history.

Also as described above, the advertising server 160, using one or more server processors, selects content to be displayed on a display device of a client computing device (when the client computing device is in a locked state in which interactions with the client computing device are limited) based on the both user information in the user profile (for example, tag information contained in the user profile) and on advertising performance data. In selecting the content to be sent to the mobile computing device 100, the one or more server processors of the advertising server 160 may use one or both of:
information in the user profile identified by the identifier sent in the request for content from the mobile computing device 100; and
advertising performance data associated with advertising content stored in advertising content database 172.

When the user dismisses the advertisement screen (being either the lock screen with integrated advertising content, or a screen having advertising content which, when dismissed, exposes the lock screen), they may do so by providing feedback user input through one or more user inputs. For example, as described above, they may adopt a dismissal technique that provides either positive or negative feedback on the advertising content. Where feedback user input is provided, the mobile computing device 100 uses the one or more processors 114 to generate new advertising performance data based on that feedback user input, and send the new advertising performance data to the advertising server 160 using network interface component 118, together with an identifier identifying the advertising content, and an identifier identifying a user profile.

The one or more server processors of the advertising server can use the new advertising performance data it receives to update one or both of the existing advertising performance data, and the user information. For example, the message sent to the advertising server 160 through the computer network 140 may be:

[TJ586684] [AD766543] [N]

where [TJ586684] is a unique identifier which identifies the user profile of Mr. Tom Jones, [AD766543] is an advertising content identifier identifying an advertisement image, and [N] indicates that the feedback user input represented negative feedback. The advertisement image identified by AD766543 is for ladies underwear. Tom Jones' profile only indicates that he enjoys music, and is over 55 years old.

The message may additionally include other information about the displaying of the advertising content, including, for example, the geographical location at which the advertising content was displayed, and the time at which it was displayed. The message sent to the advertising server 160 through the computer network 140 forms the basis of an event record to be stored in analytics database 168 by the one or more server processors.

Although in the present example a single piece of feedback user input is sent as a single message to the advertising server 160 through the computer network 140 using a network interface component, in other embodiments feedback user input is batched together, and a single message is sent to advertising server 160 through computer network 140 containing multiple pieces of feedback user input (or multiple event records). The sending of the message(s) to the advertising server 160 using a network interface component may be scheduled to take place periodically, or on the satisfaction of any other conditions (e.g., the mobile computing device having WiFi connectivity).

The one or more server processors of advertising server 160 may use the information in the message sent to it by the mobile computing device to alter the existing advertising performance data, recording that AD766543 was disliked by somebody in the 55+ age bracket. This data would reduce the probability that AD766543 would be selected to be sent to mobile computing devices 100 associated with user profiles where the user profile records an age above 55. As described above, the modification or alteration of existing advertising performance data by the one or more server processors may take the form of adding an event record to a collection of event records associated with advertising content.

The one or more processors of advertising server 160 may also use the information in the message sent to it through the computer network 140 by the mobile computing device to update the user information in the TJ586684 user profile. For example, the user profile may be altered by the one or more server processors to record that Mr Jones is not interested in ladies underwear. This would reduce the probability that advertising content tagged as ladies underwear would be determined to be sent to a mobile computing device 100 associated with the TJ586684 user profile. The user information in the user profile may also be altered by adding an event record to a collection of event records associated with the user profile.

### User Benefits

User profiles preferably contain benefit account information of the user. The benefit account information should be sufficient to enable benefits to be provided to the user. For example, the benefit account information could include financial account details that would enable funds to be deposited into the user's bank account, possibly using an externally provided transaction processor. Alternatively, the benefit account information could be information regarding the user's telecommunications service account, enabling a transaction processor to execute a transaction providing the user with a partial refund or rebate on the charges associated with their telecommunications service.

Upon receipt of a message from a client (possibly mobile) computing device 100 containing advertising performance data associated with user information in a user profile (through a user profile identifier, a client device identifier and the like), where the advertising performance data has been generated by the one or more processors of a client computing device based on user input, such as the example message above, the advertising server 160 may, using one or more server processors, provide the user with a benefit using the benefit account information in the user's profile.

Using the example message above, Tom Jones has provided negative feedback on advertising content. As a reward for providing feedback on advertising content (or alternatively, as a reward for simply viewing the advertising content), Mr Jones may be provided with a voucher for a music store (the choice of benefit reflecting information about Mr Jones in the user profile). Alternatively, the advertising server 160 may transmit a message to a transaction processor to execute a transaction deposting funds into Mr Jones' bank account, the details of which are recorded in his user profile. In such an embodiment, the message sent by the advertising server 160 to the transaction processor may include at least the amount of the transaction. The amount of the transaction may be selected by the advertising server 160 based, at least in part, on the advertising performance data. For example, if a large amount of advertising performance data is received from the user, the amount of the transaction may be higher.

Benefits may be provided to the user even if the user profile does not contain benefit information. For example, the user may be provided with gift vouchers, electronic coupon codes (for gifts, discounts and the like), a downloadable software application, and other similar benefits. Other benefits are known in the art, and the present invention is equally applicable to all benefit types.

The advertising server 160 may, through one or more server processors, only choose to execute the transaction (or transmit a message to a transaction processor to execute a transaction) using the benefit account information in a user's profile (or otherwise provide a benefit to the user) where that user has provided sufficient feedback (or has viewed a sufficient number of advertisements). For example, Mr Jones may only receive a deposit of funds into his bank account after every 10 messages from his device which incorporate new advertising performance data. That is, the advertising server 160 may only deposit funds into Mr Jones' bank account after it receives a threshold amount of advertising performance data (where that data is associated with Mr Jones' user profile).

Many modifications will be apparent to those skilled in the art without parting from the scope of the present invention as herein described. For example, although in the embodiments above the user device is a mobile computing device 100, the user device may not be mobile, and only need be connected to advertising server 160 through a computer network, preferably the Internet.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method executable at an advertising server connected, through a computer network, to a client computing device, the method comprising the steps of:
receiving through the computer network, from the client computing device, new advertising performance data relating to advertising content displayed on a display of the computing device when the client computing device was in a locked state in which interactions with the client computing device were limited, the new advertising performance data having been generated by the client computing device based on feedback user input;
updating, using one or more server processors, existing advertising performance data for the advertising content by use of the new advertising performance data to generate updated advertising performance data;
selecting, using one or more server processors, advertising content to be sent to the client computing device based, at least in part, on the updated advertising performance data.

2. A method as claimed in claim 1, wherein the step of receiving new advertising performance data includes the step of receiving new advertising performance data associated with an identifier identifying the advertising content.

3. A method as claimed in claim 1, wherein the feedback user input causing the client computing device to enter an unlocked state from the locked state.

4. A method as claimed in claim 1, wherein the new advertising performance data represents one of:
positive feedback on the advertising content; and
negative feedback on the advertising content.

5. A method as claimed in claim 1, further comprising the steps of:
receiving, through the computer network, from the client computing device, an identifier identifying a user profile;
updating, via one or more server processors, using the new advertising performance data, user information in the user profile to generate an updated user profile;
and wherein the step of selecting advertising content to be sent to the client computing device includes selecting advertising content based, at least in part, an information in the updated user profile.

6. A method as claimed in claim 5, wherein the advertising server receives new advertising performance data generated by client computing device based on feedback user input, the feedback user input causing the client computing device to enter an unlocked state from the locked state.

7. A method as claimed in claim 5, wherein the new advertising performance data represents one of:
positive feedback on the advertising content; and
negative feedback on the advertising content.

8. A method as claimed in claim 1, wherein the step of receiving new advertising performance data includes receiving new advertising performance data associated with user information, the user information including at least user benefit account information, the method further including the step of executing a transaction using the benefit account information.

9. A method as claimed in claim 8, wherein the nature and amount of the transaction is selected based, at least in part, on the advertising performance data.

10. A method as claimed in claim 8, wherein the user benefit account information includes financial account information and, the advertising server deposits funds into a financial institution account identified by the user financial account information upon receiving the advertising performance data.

11. A method as claimed in claim 10, wherein the advertising server deposits funds into a financial institution account identified by the user financial account information upon receiving a threshold amount of advertising performance data.

12. A method as claimed is claim 1, wherein the step of receiving new advertising performance data includes receiving new advertising performance data associated with user information, the user information including at least user benefit account information, the method further including the step of transmitting a message to a transaction processor to cause the transaction processor to execute a transaction using the benefit account information.

13. A method as claimed in claim 12, wherein the message includes an indication of the amount of the transaction.

14. A method as claimed in claim 13, wherein the amount of the transaction is selected based, at least in part, on the advertising performance data.

14. A method as claimed in claim 12, wherein the user benefit account information includes financial account information and, the advertising server transmits a message to a transaction processor to cause the transaction processor to deposits funds into a financial institution account identified by the user financial account information upon receiving the advertising performance data.

15. A method as claimed in claim 10, wherein the advertising server transmits a message to a transaction processor to cause the transaction processor to deposits funds into a financial institution account identified by the user financial account information upon receiving a threshold amount of advertising performance data.

16. A method as claimed in claim 1, further comprising the steps of:
receiving through the computer network, from the client computing device, authentication details received from the user by the client computing device through one or more user inputs;
using the received authentication details to retrieve from other computing devices information about the user;
generating, using one or more server processors, a user profile, based on the retrieved information about the user.

17. A method as claimed in claim 16, further comprising the step of transmitting the generated user profile to the client computing device.

18. A computer-readable medium having computer-executable instructions which, when executed by a computing device, result in the execution of a method as claimed in claim 1.
